(19) United States
(12) Patent Application Publication
(10) Pub. No.: US 2021/0303330 A1
(43) Pub. Date: Sep. 30, 2021

(54) SYSTEM FOR PROVIDING ACCESS TO A VIRTUAL MACHINE VIA A HUB INTERFACE

(71) Applicant: Euiogio Francisco Veliz Lucero, III, Oxnard, CA (US)

(72) Inventor: Euiogio Francisco Veliz Lucero, III, Oxnard, CA (US)

(21) Appl. No.: 17/211,683

(22) Filed: Mar. 24, 2021

Related U.S. Application Data
(60) Provisional application No. 62/993,806, filed on Mar. 24, 2020.

(51) Int. Cl. G06F 9/455; G06F 9/4401; G06F 21/31; G06F 13/40

(52) U.S. Cl. CPC G06F 9/45558; G06F 9/4406; G06F 21/31; G06F 2009/45587; G06F 13/4068; G06F 2009/45595; G06F 13/409

(57) ABSTRACT

A system for providing access to a virtual machine via a hub interface enables a user to access a virtual machine on a client-side computing device such as a desktop or a laptop computer. The virtual machine is hosted by a remote server and networked to the client device via the hub interface. The necessity of having the hub physically engaged with the client device in order to network with the virtual machine as hosted by the service provides a security feature as well as providing a convenient solution to accessing the server and virtual machine on a variety of client devices merely by interchanging the physical hub between those client devices. The hub itself contains an operating system which hosts the virtual machine from the hub, and which the client device may boot from, providing performance advantages for client devices which have low-performance or damaged components.

### CROSS-REFERENCE TO RELATED APPLICATION(S)

The present application is related to and claims priority to U.S. Provisional Patent Application No. 62/993,806 filed Mar. 24, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of computer networking of virtual machines of existing art and more specifically relates to a system for providing access to a virtual machine via a hub interface.

### RELATED ART

The modern workplace is dynamic and requires increasingly flexible and efficient solutions to maximize productivity. Computers have greatly increased the potential efficiency of many industries. However, increased reliance on computers has also introduced inefficiencies and inflexibilities into the workplace. When data is stored on a computer, it becomes impossible to access that data in situations where using the computer is impractical. Many solutions have been introduced to address this problem: laptop computers which can be carried on one's person, filesharing networks which permit access to data from multiple devices, and mobile phones which combine communications technology with computing technology. However, these solutions have their limitations, and the addition of each to a user's logistics have exponentially swelled the complexity of the technical understanding an employee or entrepreneur requires. Furthermore, managing this multitude of distinct devices and networks means that more time is spent trying to manage technology, and less time is spent on the work that this very technology is meant to expedite. Accordingly, there is perceived a need for a new solution that transcends the location- and hardware-based limitations of traditional computers, but which also does not overburden the end user with technological management.

U.S. Pat. No. 8,640,126 to Yaron Halperin et al. relates to extending server-bvbased desktop virtual machine architecture to client machines. Yaron attempts to improve the logistics of workplace technology by providing a server-based virtual machine which can be accessed by a user-end client machine. However, Yaron's solution has disadvantages when it comes to the limitations of the user-end machine required, and the security concerns entailed by accessing a server-based virtual machine. Still further improvement on this solution is desired.

### SUMMARY OF THE INVENTION

In view of the foregoing disadvantages inherent in the known computer networking art, the present disclosure provides a novel system for providing access to a virtual machine via a hub interface. The general purpose of the present disclosure, which will be described subsequently in greater detail, is to provide a system for providing access to a virtual machine via a hub interface.

A system for providing access to a virtual machine via a hub interface enables a user to access a virtual machine on a client-side computing device such as a desktop or a laptop computer. The virtual machine is hosted by a remote server and networked to the client device via the hub interface. The necessity of having the hub physically engaged with the client device in order to network with the virtual machine as hosted by the service provides a security feature as well as providing a convenient solution to accessing the server and virtual machine on a variety of client devices merely by interchanging the physical hub between those client devices. The hub itself contains an operating system which hosts the virtual machine from the hub, and which the client device may boot from, providing performance advantages for client devices which have low-performance or damaged components.

Furthermore, a method for accessing a virtual machine via the disclosed system using the hub interface is disclosed. A user may utilize the system by inserting the hub into a USB port or other digital socket of the computing device, powering the computing device on, entering a bios settings graphical user interface of the computing device (that is, a BIOS screen), changing the boot order priority for the client-side computing device from a default boot to a USB input into which the hub is plugged, inputting login credentials into the client-side device to access the server and/or a user account, and entering a graphical user interface of the virtual machine as downloaded or virtualized on the client-side computing device from the server.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system for providing access to a virtual machine via a hub interface, constructed and operative according to the teachings of the present disclosure.

FIG. 1 is a diagram of the system for providing access to a virtual machine via a hub interface during an ‘in-use’ condition, according to an embodiment of the present disclosure.

FIG. 2 is a method of use for utilizing the system of FIG. 1, according to an embodiment of the present disclosure.

FIG. 3 is a diagram of the construction of the hub of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a virtual machine and more particularly to a system for providing access to a virtual machine via a hub interface as used to improve the logistics of accessing data from multiple machines.

A system is herein disclosed which enables a user to access a virtual machine on a client device, the virtual machine being hosted by a remote server. However, unlike prior art solutions which access the server via an internet browser or otherwise insecure connection, the presently disclosed system utilizes a physical hub device to network the client to the server. This provides a security feature as well as providing a convenient solution to accessing the server and virtual machine on a variety of client devices merely by interchanging the physical hub. Furthermore, the hub includes hardware and software which allows the client device to outsource the operating system which hosts the virtual machine from the hub, providing performance advantages.

The following terms are defined here as used in this specification. “USB” refers to the industry-standardized Universal Serial Bus specification. In the context of this specification, “USB” may also be used as an abbreviation for a USB-standard interface. “RAM” indicates random-access memory. “BIOS” indicates a Basic Input/Output system, which is known in the industry to generally mean firmware used in computing systems to initialize a booting process to load an operating system. “Operating System” denotes a software program which allows a computing device to perform basic functions.

The device may be termed a “hub” or “dongle”. This hub (referred to by identifier 200 in this specification) is the physical device which may interact with a variety of computing devices in order to enact a virtual machine upon that computing device. Within this specification, the computing device may be also referred to as a client device. This computing device must include at least the following functional components: a keyboard; a video display; and a mouse. For this reason, the computing device upon which the virtual machine may operate (via an operating system provided upon the hub) may be referred to as a “KVM”. Here, the keyboard may include any interface which permits the input of alphanumeric characters. The mouse may be any mouse or mousepad. An advantage of this system is that the hub can be used to quickly boot the virtual machine upon various devices interchangeably. For users travelling amongst different settings for work or other purposes, who may be dependent upon desktop system or who do not wish to travel with a laptop due to concerns of theft, damage, or inconvenience, the interchangeability of the hub into various machines and the ability to quickly boot a KVM for the dongle represents a significant advantage.

It is well known in the industry to use cloud servers to store data. However, when a user utilizes traditional cloud solutions to access the same data on multiple devices, reaching that data can be an inconvenient process. The user must firstly log into the device, the device being operational and able to process computing functions. Next, the user must boot either a browser or an explorer-type program which has specific software for the filesharing service pre-installed. Then, the user must log into the file-sharing service. As an additional step, using a browser may require additional steps of navigating to the file-sharing website. Lastly, the user must find files within a common-use filesharing system (for example, a company filesharing network) as opposed to a file system which is tailored to the device and ser-tailored.

In contrast, the presently disclosed system greatly simplifies this process to a single step. The user must only log in to the cloud server containing the virtual machine once the virtual machine boots from the hub. All other file navigation is common to the virtual machine and user-defined. By user-defined, what is meant is that the user customizes their virtual machine just as they would organize files, icons, shortcuts, programs, etc. upon a conventional desktop, and these settings will remain identical, customizable, and saved to the virtual machine regardless of what KVM the hub is connected to.

It is also known in the art to log into a virtual machine via a cloud server. However, the known methods of doing this still require complicated steps of using a browser or another program to navigate to and log into the server. In the present disclosure, this process is automated (except for entering the login credentials themselves) by the hub. The hub also serves an additional purpose as a security device: the virtual machine may, in certain embodiments or by choice of the user's settings, be inaccessible without the hub. This advantage cannot be shared by virtual machines which are accessed purely by software. However, alternative embodiments may offer users an option to log into the virtual machine by software means (i.e. a browser upon a fully operating computing device) if the user desires such an option.

Another substantial advantage of this system is that the KVM can be a device which may be unusable without use of the hub device. For example, the KVM may have a corrupted operating system or hard drive damage. By booting the operating system from the hub and loading a virtual machine upon the KVM, these damaged systems may be bypassed. In use, the KVM must boot from the BIOS and the hub selected as the boot device. Usually, this will be enacted by plugging the hub into a USB port of the KVM and booting from the USB port in the BIOS selection. Accordingly, since BIOS is loaded directly from the motherboard of the KVM, the hard drive and KVM operating system are bypassed. Damaged RAM may also be bypassed. However, a functional CPU in the KVM is required for most hardware. In this way, the hub may be used to restore functionality to an otherwise unusable machine.

The CPU of the KVM does not need to function at full capacity or be of significant performance when the hub is in use, as the CPU is primarily used only to run the BIOS in order that the KVM can boot from the hub. This is because once the user has logged into their hosting service via the KVM interfaces, the virtual machine is booted, and the processing functions of the virtual machine occur on the server, not the KVM hardware. Accordingly, very outdated KVM devices which do not have sufficient processing power to operate modern operating systems may still be utilized with modern operating systems (via the virtual machine) when the hub is used. Neither does the KVM need to provide any storage or antivirus capabilities.

The term “dongle” is used to mean “a module that plugs into and sticks out of a socket”. The dongle (hub) must include an interface to mechanically connect and digitally communicate with the KVM. In a preferred embodiment, the interface is a male USB plug which interfaces with USB sockets of the KVM.

The hub itself may include the following components: the interface; a printed circuit board hosting a hub-software; a wireless transceiver; and a housing mechanically containing the above components. The wireless transceiver may include an antenna and, optionally, hardware components able to enact various wireless protocols. For example, the antenna may include a WiFi card (protocols of IEEE 802.11) or a Bluetooth card (protocol IEEE 802.15.1). Other wireless protocols may be implemented in various embodiments. However, WiFi functionality is desired for wirelessly connecting the hub to a wireless internet router, as an internet connection is necessary to link the server hosting the virtual machine to the hub (and accordingly the KVM). As an alternative, Bluetooth functionality may offer a convenient solution to connect the hub to a mobile device able to provide a data connection. As before, it is preferred that the interface be a male USB plug capable of interacting with USB 2.0, USB 3.0, etc. However, some embodiments may utilize alternative interfaces such as USB-C, Ethernet, HDMI, Thunderbolt, and others.

In yet another embodiment an alternative form of wireless communication is envisioned. In such an embodiment, the hub may include a SIM (Subscriber Identity Module) card to utilize data or telephone protocols to connect to the remote server.

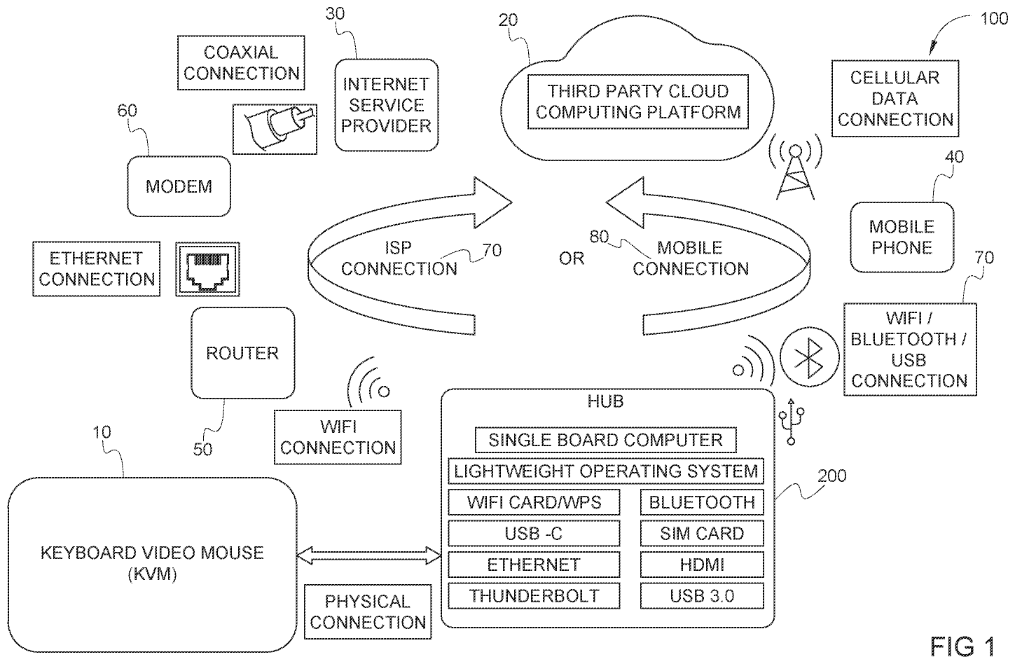

Referring now more specifically to the drawings by numerals of reference, there is shown in FIGS. 1-3, various views of a system 100.

FIG. 1 shows a system 100 for operating a virtual machine upon a client device during an ‘in-use’ condition, according to an embodiment of the present disclosure. Here, the system 100 may be beneficial for use by a user to securely and conveniently access a virtual machine upon a client device. As illustrated, the system 100 may include a client-side computing device 10 (also referred to as a KVM device). Computing device 10 may receive data from hub 200. Such data may include an operating system and data to operate a virtual machine (not illustrated) upon computing device 10. For the purposes of this specification, this may be referred to as “virtualizing” the virtual machine upon the client device, entailing downloading data continuously from the server as the virtual machine operates, much in the same fashion as multimedia is referred to as being “streamed” from a server to a client device. However, in some embodiments, some functions of the virtual machine may be processed upon the hub or KVM in conjunction with the operating system installed on the hub as required for efficient computing operation. As illustrated, hub 200 must be physically connected to computing device 10 in order to communicate with computing device 10, as is preferred for security purposes. In this way, hub 200 serves a secondary function as a physical “key” required for accessing the virtual machine from computing device 10. Hub 200 may be able to communicate (preferably wirelessly) with router 50 and/or modem 60. Via these devices hub 200 may be connected to internet service via an Internet Service Provider (ISP) 30. Once connected to internet service, hub 200 may exchange data with third party cloud computing platform 20.

In an alternate method, hub 200 may be able to connect to the internet via a Bluetooth or SIM connection with a mobile phone device 40. If the mobile phone device 40 is connected to a cellular data network, it may be able to provide internet service to hub 200 in this manner.

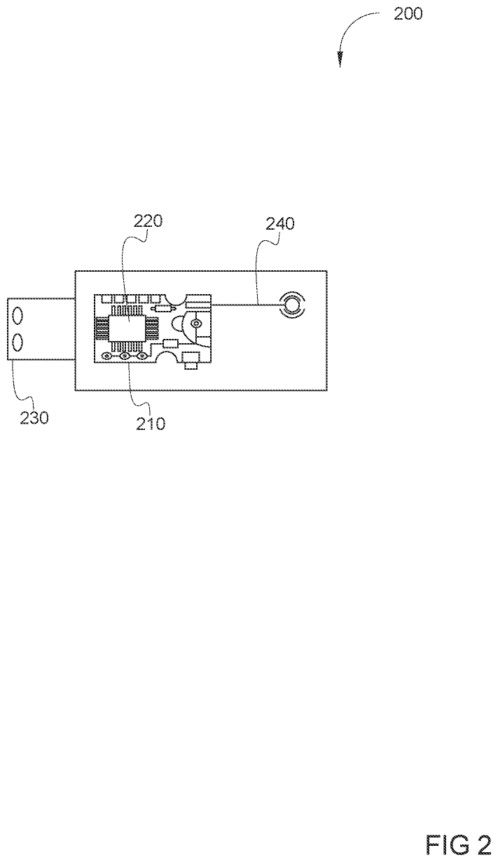

FIG. 2 shows a method of use for utilizing the system of FIG. 1, according to an embodiment of the present disclosure. The method of use may be subdivided into initial setup with a client-side computing device, initiating a user-account, and accessing a user-account.

Initiating setup with a client-side computing device may include the following steps: step one 301, inserting the hub into the client-side computing device; step two 302, powering the client-side computing device; step three 303, accessing BIOS upon the client-side computing device; step four 304, changing boot order priority to the interface input; step five 305 (optional), powering off the client-side computing device.

Initiating a user-account may include the following steps: step one 401, powering the client-side computing device step two 402, prompting user for network settings; step three 501, querying user for at least one network (such as a wireless home network as primary and a phone hotspot as secondary); step four 502, querying if user is a new user; step five 503, requesting user to creating a user account with a corresponding username and password; step six 601, launching a web browser; step seven 602, querying a user for virtual machine settings; step eight 603, querying user for payment information; and step nine 604, querying user create (i.e. enter) username and password.

Accessing a user-account may include the following steps: step one 701, querying user for login credentials (i.e. username and password); step two 702, load the virtual machine corresponding to the user credentials and account via the hub operating system; and step three 703, entering a desktop of the virtual machine.

All method steps may be concluded by the step of powering off client-side computing device 403.

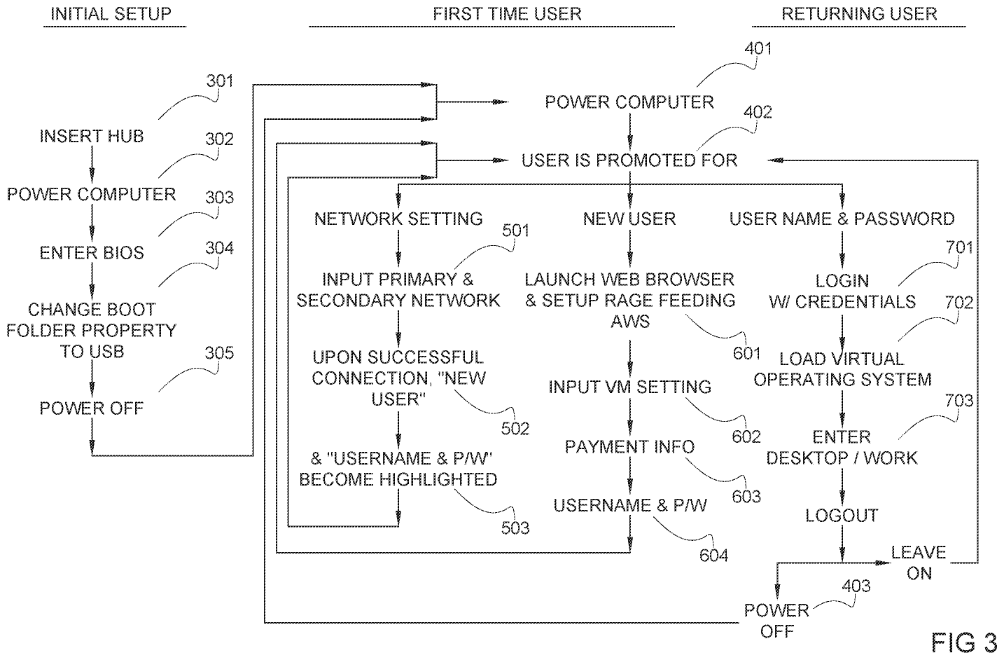

FIG. 3 is a diagram of the hub of FIG. 1, according to an embodiment of the present disclosure. Hub (or dongle) 200 may be able to communicate with client-side computing device 10. Hub 200 may itself include printed circuit board 210, processor 220, interface 230, and transceiver 240. Interface 230 may be able to mechanically and digitally engage with client device 10. Wireless transceiver 240 may be digitally coupled to the printed circuit board and may be able to wirelessly communicate with an external electronic device, such as a wireless router, a mobile phone device, etc.

Hub 200 may host pre-installed software, which may include at least an operating system and a protocol. This software program may be installed upon the printed circuit board and enacted by the processor, being able to virtualize the desktop (i.e. of the virtual machine) to the client device. The software program may comprise a user-validation protocol, the user-validation protocol comprising: verifying that the dongle is interfaced with the client device, querying a user for user-credentials, verifying submitted user-credentials, sourcing the virtual machine, the virtual machine corresponding to the user-credentials, and virtualizing the desktop to the client device.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for operating a virtual machine upon a client device comprising:
a virtual machine hosted upon a server;
a dongle able to communicate with the computing device, the dongle comprising
a printed circuit board,
an interface able to mechanically and digitally engage with the client device, the interface being both mechanical and digital in functionality,
a wireless transceiver (ISP or mobile data connection) digitally coupled to the printed circuit board and able to wirelessly communicate with an external electronic device;
a software program installed upon the printed circuit board, the software program being able to continually download the virtual machine to the client device and upload inputs from the client device to the server;
whereby the software program comprises a user-validation protocol, the user-validation protocol comprising
verifying that the dongle is interfaced with the client device,
querying a user for user-credentials,
verifying submitted user-credentials,
sourcing the virtual machine from the server, the virtual machine corresponding to the user-credentials, and
downloading the virtual machine to the client device.

2. The system of claim 1, wherein the wireless transceiver comprises a Bluetooth card.

3. The system of claim 1, wherein the interface is a USB interface.

4. The system of claim 1, wherein the wireless transceiver comprises a WiFi card.

5. The system of claim 1, wherein the computing device comprises at least a keyboard, a mouse, and a display.

6. The system of claim 1, wherein the virtual machine is hosted via a remote cloud computing platform.

7. The system of claim 1, wherein the printed circuit board hosts an operating system, the computing device being able to boot using the operating system when the dongle is interfaced with the computing device.

8. A method of using the system of claim 1, the method comprising the steps of:
inserting the interface of the dongle into a digital receptacle of the computing device;
powering the computing device;
entering a bios settings graphical user interface of the computing device;
changing boot order priority for the computing device to the digital receptacle;
prompting a user to input login credentials and alternatively prompting the user to create login credentials; and
entering a graphical user interface of the virtual machine.
